(19) United States
(12) Patent Application Publication
(10) Pub. No.: US 2011/0184980 A1
(43) Pub. Date: Jul. 28, 2011

(54) APPARATUS AND METHOD FOR PROVIDING IMAGE

(75) Inventors: Jin-guk JEONG, Yongin-si (KR); Soo-hong PARK, Yongin-si (KR); Hui MIAO, Suwon-si (KR)

(73) Assignee: SAMSUNG ELECTRONICS CO., LTD., Suwon-si (KR)

(21) Appl. No.: 12/982,207

(22) Filed: Dec. 30, 2010

(30) Foreign Application Priority Data
Jan. 28, 2010 (KR) 10-2010-0008048

(51) Int. Cl. G06F 17/30

(52) U.S. Cl. 707/771; 707/769; 707/E17.031

(57) ABSTRACT

An apparatus for providing an image is provided. The apparatus including a storage unit for storing an image, a receiving unit for receiving an event associated with a predetermined image from an external device, an additional information extracting unit for extracting additional information from the stored image, a filtering unit for selecting at least one image corresponding to the event through filtering, and a transmission unit for transmitting the selected image.

### CROSS-REFERENCE TO RELATED PATENT APPLICATION

This application claims priority from Korean Patent Application No. 10-2010-0008048, filed on Jan. 28, 2010, in the Korean Intellectual Property Office, the disclosure of which is incorporated herein in its entirety by reference.

### BACKGROUND

1. Field

Apparatuses and methods consistent with the exemplary embodiments relate to an apparatus for providing an image and a method thereof, and more particularly, to an apparatus for selecting an image through filtering using metadata and providing the selected image and a method thereof.

2. Description of the Related Art

Recently, instead of related art photo frames in which it is difficult to change photographs, electronic photo frames, or digital photo frames have been developed.

Such an electronic photo frame means a digital device for receiving and storing photographs captured by a digital camera or the like in a memory card included therein and displaying stored photographs on a 5-12 inch sized Liquid Crystal Display (LCD) screen. Presently, in order to upload or update photographs, such an electronic photo frame manually uploads or updates the photographs by connecting with a computer, a memory card, or a camera.

### SUMMARY OF THE EXEMPLARY EMBODIMENTS

The exemplary embodiments provide an apparatus for automatically updating or uploading an image displayed on an image display device using metadata and a method thereof.

According to an aspect of the exemplary embodiments, there is provided an apparatus for providing an image, the apparatus comprising: a storage unit for storing an image; a receiving unit for receiving an event associated with a predetermined image from an external device; an additional information extracting unit for extracting additional information from the stored image; a filtering unit for selecting at least one image corresponding to the event through filtering; and a transmission unit for transmitting the selected image.

The additional information may be stored in an image in a form of metadata, and the additional information extracting unit may extract the additional information by parsing the metadata from the stored image.

The additional information may include information on at least one of a person, a place, and a time associated with an image.

The additional information on a place may be Global Positioning System (GPS) information.

The GPS information may be stored in a form of metadata converted to position information indicating an address using a predetermined map.

The additional information extracting unit may receive metadata associated with the stored image from a predetermined database.

The apparatus may further comprise a metadata generation unit for generating and storing metadata on an image generated through capturing.

A metadata framework on the operation of extracting or generating and storing metadata may be constructed in a structure including an application layer, an Application Programming Interface (API) layer, a data model layer, and a storage layer.

The metadata framework may be constructed in a structure further including a metadata repository in which a data structure and a storing method are previously defined based on a type of the metadata.

The data model layer may include at least one of a Hash-based data model, a tree-based data model, and a graph-based data model.

According to another aspect of the exemplary embodiments, there is provided a method for providing an image, the method comprising: receiving an event associated with a predetermined image from an external device; extracting additional information from a stored image; selecting at least one image corresponding to the event through filtering based on the extracted additional information; and transmitting the selected image to an external device.

### BRIEF DESCRIPTION OF THE DRAWINGS

The above and other aspects of the exemplary embodiments will become more apparent by describing in detail exemplary embodiments thereof with reference to the attached drawings in which:

FIG. 1 is a block diagram of an image providing apparatus and an image display device according to an exemplary embodiment;

FIG. 2 illustrates a form in which metadata is stored in a Joint Photographic Experts Group (JPEG) field;

FIG. 3 illustrates Exif according to an exemplary embodiment;

FIG. 4 illustrates event setup according to an exemplary embodiment;

FIG. 5 illustrates a structure of a metadata framework working in an image capturing device or an image providing apparatus according to an exemplary embodiment; and

FIG. 6 is a flowchart of an image providing method according to an exemplary embodiment.

### DETAILED DESCRIPTION OF THE EXEMPLARY EMBODIMENTS

The exemplary embodiments will now be described more fully with reference to the accompanying drawings, in which exemplary embodiments.

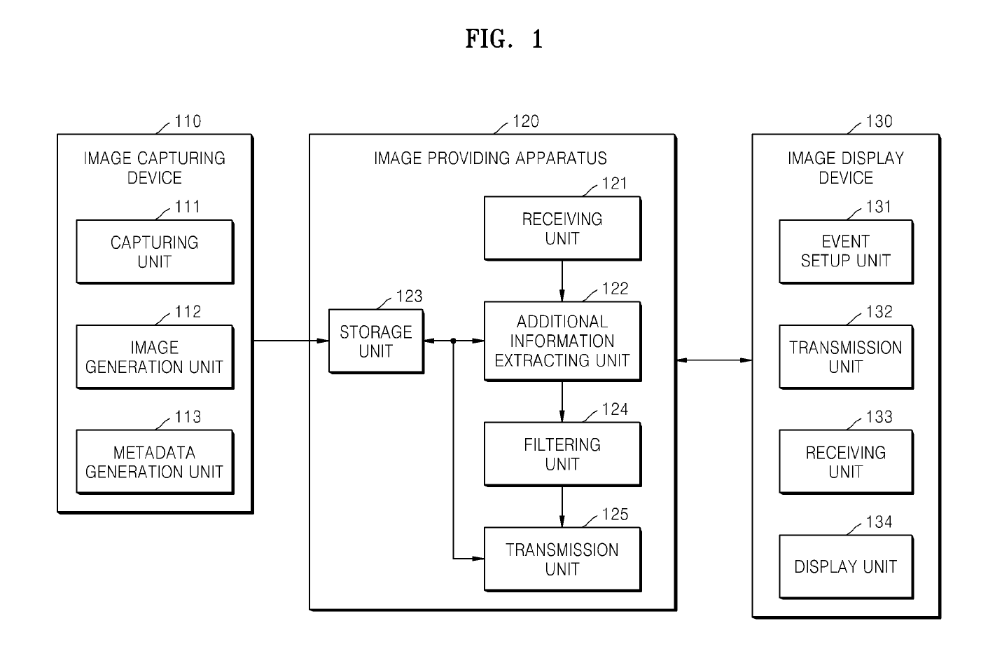

FIG. 1 is a block diagram of an image providing apparatus 120 and an image display device 130 according to an exemplary embodiment.

Referring to FIG. 1, an image capturing device 110 includes a capturing unit 111, an image generation unit 112, and a metadata generation unit 113, the image providing apparatus 120 includes a receiving unit 121, an additional information extracting unit 122, a storage unit 123, a filtering unit 124, and a transmission unit 125, and the image display device 130 includes an event setup unit 131, a transmission unit 132, a receiving unit 133, and a display unit 134.

The image providing apparatus 120 and the image display device 130 can connect with each other via a wireless network, such as Wi-Fi or Bluetooth, or a predetermined wired network.

The image providing apparatus 120 may be included in the image capturing device 110 such as a camera or a terminal, such as a cellular phone, in which a camera is included or it may be included in a device acting as a home server or a Personal Computer (PC). The image display device 130 may be, for example, a general device by which photographs can be displayed.

The capturing unit 111 of the image capturing device 110 captures an object. Then the image generation unit 112 generates an image such as a Joint Photographic Experts Group (JPEG) image. The metadata generation unit 113 generates metadata associated with the image and inserts the metadata into the image or transmits the metadata to a database to store it therein. Detailed description on metadata will be provided later.

The receiving unit 121 of the image providing apparatus 120 receives information on a set event from the image display device 130. Detailed description on event setup will be provided later.

The additional information extracting unit 122 extracts additional information on an image, for example, a photograph, stored in the storage unit 123. According to an exemplary embodiment, additional information on an image can be stored in the image in a form of metadata. The additional information extracting unit 122 extracts and parses metadata from the stored image.

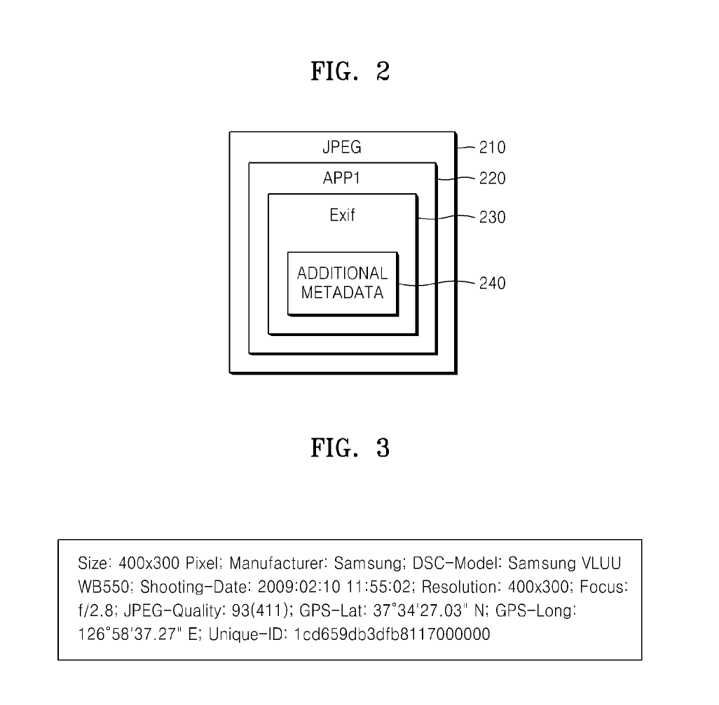

Since most photographs captured presently are stored in a JPEG file format, description associated with JPEG is illustrated. FIG. 2 illustrates a form in which metadata is stored in a JPEG field 210. An APP1 field 220 is a space for storing metadata in the JPEG field 210. Exif, that is, an exchange image file format, is a metadata format used as a standard in JPEG. That is, Exif is metadata including information on an image (photograph). In an Exif field 230, information on when and where an image is captured can be stored. When capturing an object, the image capturing device 110 can extract a system time thereof and store the system time as time information in the Exif field 230, and acquire position information by receiving a Global Positioning System (GPS) signal by means of a GPS receiving unit included therein and store the position information as place information in the Exif field 230. In general, the GPS signal includes coordinate information such as latitude and longitude. For example, the coordinate information may be geographic coordinate information in which a position is displayed with east longitude and north latitude such as ‘E127:00:09.00 N37:26:08.00’. Since various contents can be stored in the Exif field 230 as additional information on an image, there is no limit to the contents.

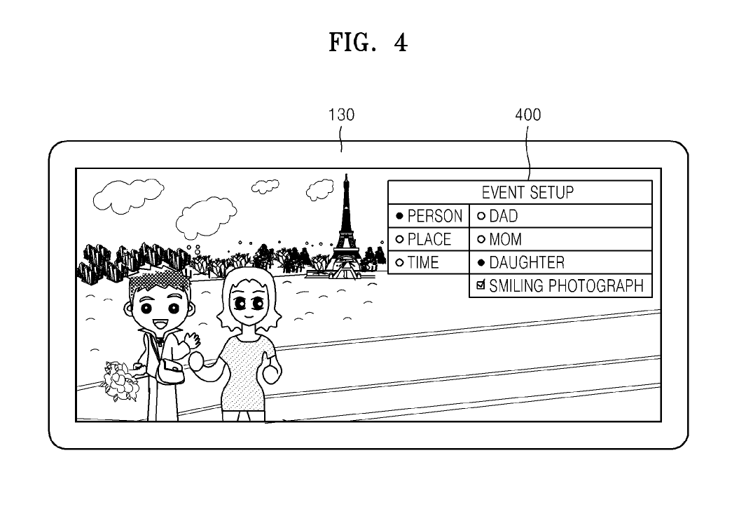

FIG. 3 illustrates Exif according to an exemplary embodiment. Referring to FIG. 3, Exif includes information on, for example, the size of a photograph, the manufacturer of a camera, camera model (DSC-model), the shooting-date, the resolution, the focus, JPEG-quality, GPS information (GPS-Lat and GPS-Long), and unique-ID. An additional metadata field 240 is a metadata field defined by a manufacturer of the image capturing device 110.

According to an exemplary embodiment in the additional metadata field 240, personal information, face expression information, or predetermined position information converted from GPS information can be stored. In the case of the personal information and the face expression information, since recent image capturing devices 110 include a face detection/recognition module, the image capturing device 110 can store information on who a person is and whether the person is smiling in the additional metadata field 240. In addition, in the position information, since the GPS information shows longitude information and latitude information, it is difficult for a user to determine a position from the GPS information. That is, the user can more easily understand a case of displaying a position which has an address such as “1 Sejongro Chongro-Ku Seoul”. The image capturing device 110 converts the GPS information to position information associated with an address using a map. When the image capturing device 110 has a map, the image capturing device 110 converts the GPS information to position information associated with an address using the map, and when the image capturing device 110 does not have a map, the image capturing device 110 converts the GPS information to position information associated with an address using a map of another device via a wireless or wired network. Since the converted position information associated with an address cannot be stored in the Exif field 230, the converted position information is stored in the additional metadata field 240. In addition, when an image does not include metadata, the additional information extracting unit 122 may receive additional information associated with the image from an external database via a predetermined communication network.

The storage unit 123 receives and stores an image generated by the image capturing device 110.

When the filtering unit 124 determines that additional information, i.e., metadata, extracted from an image is associated with a received event, the filtering unit 124 selects, through filtering, an image in which corresponding metadata is stored. That is, the filtering unit 124 extracts the image from the storage unit 123. For example, if the user sets an event of ‘recent photographs (it is assumed that recent means a time duration from present to one week ago)’, the filtering unit 124 extracts metadata on time information and extracts an image having time information of metadata corresponding to the time duration from present to one week ago. The number of photographs selected through filtering may be at least one, and when the extracted metadata is not associated with the received event at all, no image may be extracted.

The transmission unit 125 of the image providing apparatus 120 transmits the extracted image to the image display device 130. According to an exemplary embodiment, the image display device 130 has various extended functions, such as connection to a network. Nevertheless, there is inconvenience in that the user must search for a photograph from among many images to update an image. In this case, if the user sets an event, a corresponding image can be automatically updated or uploaded.

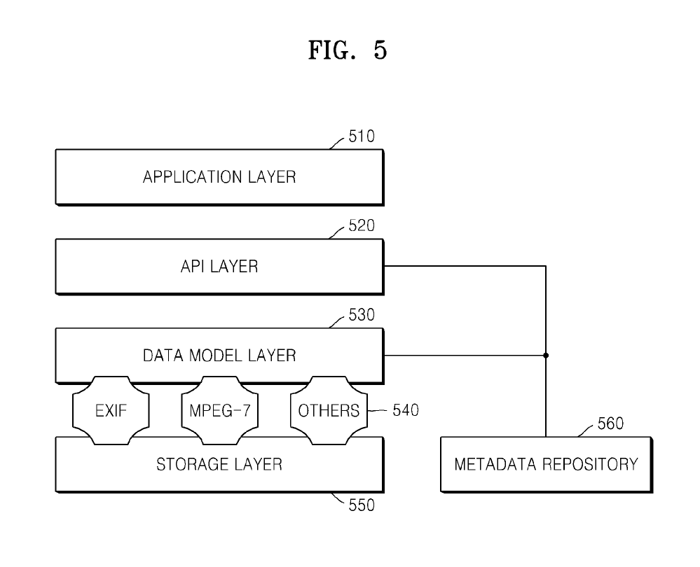

FIG. 5 illustrates a structure of a metadata framework working in an image capturing device or an image providing apparatus according to an exemplary embodiment. The metadata framework can be constructed with four layers. In detail, the metadata framework can be constructed with a storage layer 550, a data model layer 530, an Application Programming Interface (API) layer 520, and an application layer 510. The storage layer 550 is a layer corresponding to a schema in which metadata is stored. Since metadata is in one of various forms, such that it may exist in a content file, exist as an independent file, or be processed using a special metadata database, the storage layer 550 is a layer to reflect these varieties. For example, a metadata database may be used for many images to be stored or a quick extraction speed, and metadata may be inserted in an image when the number of images is few. According to an exemplary embodiment, when the image providing apparatus 120 is included in the image capturing device 110, metadata is inserted into an image file, and when the image providing apparatus 120 and the image capturing device 110 exist separately, metadata may be in a metadata database.

The data model layer 530 is a layer for enabling the application of a framework even in a heterogeneous environment by letting a user select one of various models, such as a Hash-based data model, a tree-based data model, and a graph-based data model, considering the computing power of a device in which an engine works, and a form of schema. Between the storage layer 550 and the data model layer 530, a metadata driver 540 performed according to a stored schema is mapped.

The API layer 520 is a layer for re-use of an application, such that the application code is not changed even if the inside of the metadata framework is changed, so that a module embodied in another application can be easily re-used.

In a metadata repository 560, a data structure to represent metadata and a storage method are previously defined based on a type of each metadata.

The application layer 510 operating in a corresponding framework exists.

For example, when program on a photograph capturing application is executed in the application layer 510, the metadata repository 560 recognizes from a Put(GPS) API of the API layer 520 that metadata is GPS information, selects a data model (for example, Hash-based data model) through the data model layer 530, and controls to store an image file in which the metadata is inserted in the storage layer 550 through a metadata driver 540. Such a common metadata framework can be applied even in various heterogeneous environments in a state of connecting devices to each other, and since several metadata formats can be used at the same time, a convergence function of various devices can be easily embodied.

The event setup unit 131 of the image display device 130 sets an event required by a user. That is, the user sets attributes of a photograph which the user wants to display on the image display device 130. FIG. 4 illustrates event setup according to an exemplary embodiment. Referring to FIG. 4, an event setup menu 400 is displayed on the image display device 130. The event setup menu 400 provides person, place, and time events. In addition, in case of person, a specific person can be set, and the event setup menu 400 is provided in a check box form so as to select smiling photographs through filtering. In case of time, the latest photograph can be set as an input event, and in case of place, the outdoors or a specific place name can be set. However, these are only examples and not limited in terms of object or contents.

The transmission unit 132 of the image display device 130 transmits information on an event set by the event setup unit 131 to the image providing apparatus 120 when the image display device 130 and the image providing apparatus 120 are connected to each other via a predetermined communication network.

The receiving unit 133 of the image display device 130 receives an image selected through filtering from the image providing apparatus 120, and the display unit 134 displays the received image. If the number of received images is plural, the display unit 134 may display the received images in a slide show form.

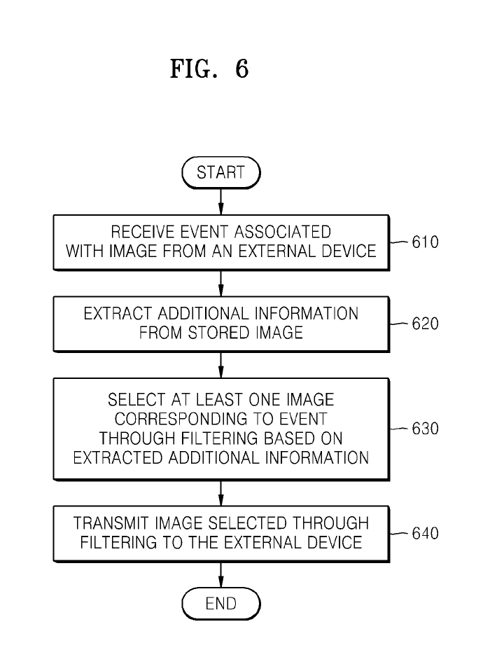

FIG. 6 is a flowchart of an image providing method according to an exemplary embodiment.

Referring to FIG. 6, an image providing apparatus receives an event associated with a predetermined image from an external device in step 610. The image providing apparatus is connected to the external device via a wireless network, such as Wi-Fi or Bluetooth, or a predetermined wired network and receives information on an event set by a user from the external device. For the event, the user can set a desired event. That is, the user can set attributes on a photograph which the user wants to display on an image display device. Examples of the event are person, place, and time events. In case of a person, a specific person can be set, and may be set to select smiling photographs through filtering. In case of a time, the latest photograph can be set as an input event, and in case of a place, the outdoors or a specific place name can be set. However, these are only examples and not limited in terms of object or contents.

The image providing apparatus extracts additional information of an image stored in a storage unit thereof in step 620. According to an exemplary embodiment, additional information of an image can be stored in the image in a form of metadata. The image providing apparatus parses metadata from the stored image. Parsing means extraction of data matching a metadata structure.

Since most photographs captured presently are stored in a JPEG file format, description associated with JPEG is illustrated. Exif that is an exchange image file format is a metadata format used as a standard in JPEG. That is, Exif is metadata including information on an image (photograph). In Exif, information on when and where an image is captured can be stored. When capturing an object, a camera can extract a system time thereof and store the system time as time information in Exif, and acquire position information by receiving a GPS signal by means of a GPS receiving unit included therein and store the position information as place information in Exif. In general, the GPS signal includes coordinate information such as latitude and longitude. For example, the coordinate information may be geographic coordinate information in which a position is displayed with east longitude and north latitude such as ‘E127:00:09.00 N37:26:08.00’. Since various contents can be stored in Exif as additional information on an image, there is no limit to the contents. For example, Exif includes information on the size of a photograph, the manufacturer of the camera, the camera model (DSC-model), the shooting-date, resolution, focus, JPEG-quality, GPS information (GPS-Lat and GPS-Long), and unique-ID, but is not limited thereto. Additional metadata is metadata defined by a manufacturer of the camera. According to an exemplary embodiment, in the additional metadata, personal information, face expression information, or predetermined position information converted from GPS information can be stored. In case of the personal information and the face expression information, since recent cameras include a face detection/recognition module recently, the camera can store information on who a person is and whether the person is smiling in the additional metadata. In addition, in the position information, since the GPS information shows longitude information and latitude information, it is difficult for a user to determine a position from the GPS information. That is, the user can more easily understand a case of displaying a position which has an address such as “1 Sejongro Chongro-Ku Seoul”. The camera converts the GPS information to position information associated with an address using a map. When the camera has a map, the camera converts the GPS information to position information associated with an address using the map, and when the camera does not have a map, the camera converts the GPS information to position information associated with an address using a map of another device via a wireless or wired network. For example, the camera can convert the GPS information to position information associated with an address using Google map via the Internet, but is not limited thereto. Since the converted position information associated with an address cannot be stored in Exif, the converted position information is stored in the additional metadata. In addition, when an image does not include metadata, the image providing apparatus may receive additional information associated with the stored image from an external database via a predetermined communication network.

The image providing apparatus selects an image corresponding to the received event through filtering based on the extracted additional information in step 630. When the image providing apparatus determines that the additional information, i.e., metadata, extracted from the image is associated with the received event, the image providing apparatus selects, through filtering, an image in which corresponding metadata is stored. That is, the image providing apparatus extracts an image in which corresponding metadata is stored from a storage unit. For example, when the user sets an event to a place ‘United States of America’, the image providing apparatus extracts metadata associated with place information and extracts an image having metadata place information in which a place corresponds to United States of America. The number of photographs selected through filtering may be at least one, and when the extracted metadata is not associated with the received event at all, no image may be extracted.

The image providing apparatus transmits the extracted image to the external device in step 640. According to an exemplary embodiment, an image display device, such as an electronic photo frame, has various extended functions, such as connection to a network. Nevertheless, there is inconvenience in that the user must search for a photograph from among many images to update an image. In this case, if the user sets an event, a corresponding image can be automatically updated or uploaded.

The image providing method as described above can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the exemplary embodiments can be easily construed by programmers skilled in the art to which the exemplary embodiments pertain.

While the exemplary embodiments have been particularly shown and described with reference to exemplary embodiments thereof, it will be understood by those of ordinary skill in the art that various changes in form and details may be made therein without departing from the spirit and scope of the exemplary embodiments as defined by the appended claims. The exemplary embodiments should be considered in descriptive sense only and not for purposes of limitation. Therefore, the scope of the exemplary embodiments is defined not by the detailed description of the exemplary embodiments but by the appended claims, and all differences within the scope will be construed as being included in the exemplary embodiments.

1. An apparatus for providing an image, the apparatus comprising:
a storage unit which stores an image;
a receiving unit which receives an event associated with a predetermined image from an external device;
an additional information extracting unit which extracts additional information from the stored image;
a filtering unit which selects at least one image corresponding to the event through filtering; and
a transmission unit which transmits the selected image to the external device.

2. The apparatus of claim 1, wherein the additional information is stored in an image in a form of metadata, and
the additional information extracting unit extracts the additional information by parsing the metadata from the stored image.

3. The apparatus of claim 1, wherein the additional information comprises information on at least one of a person, a place, and a time associated with the image.

4. The apparatus of claim 3, wherein the additional information on the place is Global Positioning System (GPS) information.

5. The apparatus of claim 4, wherein the GPS information is stored in a form of metadata converted to position information which indicates an address using a predetermined map.

6. The apparatus of claim 2, wherein the additional information extracting unit receives metadata associated with the stored image from a predetermined database.

7. The apparatus of claim 1, further comprising a metadata generation unit which generates and stores metadata on an image generated through an image capturing operation.

8. The apparatus of claim 7, wherein a metadata framework on the operation which extracts or the operation which generates and stores metadata is constructed in a structure which comprises an application layer, an Application Programming Interface (API) layer, a data model layer, and a storage layer.

9. The apparatus of claim 8, wherein the metadata framework is constructed in a structure which further comprises a metadata repository in which a data structure and a storing method are previously defined based on a type of the metadata.

10. The apparatus of claim 8, wherein the data model layer includes at least one of a Hash-based data model, a tree-based data model, and a graph-based data model.

11. A method for providing an image, the method comprising:
receiving an event associated with a predetermined image from an external device;
extracting additional information from a stored image;
selecting at least one image corresponding to the event through filtering based on the extracted additional information; and
transmitting the selected image to the external device.

12. The method of claim 11, wherein the additional information is stored in an image in a form of metadata, and
the extracting of the additional information comprises extracting the additional information by parsing the metadata from the stored image.

13. The method of claim 11, wherein the additional information comprises information on at least one of a person, a place, and a time associated with the image.

14. The method of claim 13, wherein the additional information on the place is GPS information.

15. The method of claim 14, wherein the GPS information is stored in a form of metadata converted to position information indicating an address using a predetermined map.

16. The method of claim 11, wherein the extracting of the additional information comprises receiving metadata associated with the stored image from a predetermined database.

17. (canceled)

18. The method of claim 12, wherein a metadata framework on the operation of extracting or the generating and storing metadata is constructed in a structure comprising an application layer, an Application Programming Interface (API) layer, a data model layer, and a storage layer.

19. The method of claim 18, wherein the metadata framework is constructed in a structure further comprising a metadata repository in which a data structure and a storing method are previously defined based on a type of the metadata.

20. The method of claim 18, wherein the data model layer comprises at least one of a Hash-based data model, a tree-based data model, and a graph-based data model.

21. A computer readable recording medium having embodied thereon a computer readable program for executing a method for providing an image, the method comprising:
receiving an event associated with a predetermined image from an external device;
extracting additional information from a stored image;
selecting at least one image corresponding to the event through filtering based on the extracted additional information; and
transmitting the selected image to the external device.
